(19) United States
(12) Patent Application Publication
(10) Pub. No.: US 2024/0041291 A1
(43) Pub. Date: Feb. 8, 2024

(54) CLEANING ROBOT, CLEANING METHOD, AND COMPUTER-READABLE STORAGE MEDIUM

(71) Applicant: Qfeeltech (Beijing) Co., Ltd., Beijing (CN)

(72) Inventor: Xin WU, Beijing (CN)

(21) Appl. No.: 18/484,433

(22) Filed: Oct. 10, 2023

Related U.S. Application Data
(63) Continuation of application No. PCT/CN2022/086329, filed on Apr. 12, 2022.

(30) Foreign Application Priority Data
Apr. 16, 2021 (CN) 202110411952.2

(51) Int. Cl. A47L 11/40; A47L 11/24; A47L 11/28; A47L 9/00; A47L 9/28; G05D 1/02

(52) U.S. Cl. CPC A47L 11/4011; A47L 11/4091; A47L 11/4005; A47L 11/24; A47L 11/28; A47L 9/0063; A47L 9/2852; A47L 9/2847; A47L 9/2842; A47L 9/2873; A47L 9/2884; G05D 1/0274; G05D 1/0217; A47L 2201/022; A47L 2201/06; A47L 2201/04; G05D 2201/0203

(57) ABSTRACT

The present disclosure provides a cleaning robot, a cleaning method, and a computer-readable storage medium. The cleaning method includes: obtaining a map of a closed space, the map including a plurality of rooms corresponding to the closed space. The plurality of rooms can be grouped into at least two sub-zones. Each sub-zone includes at least one room, each room included in each sub-zone belongs only to this sub-zone. The cleaning method also includes cleaning a first sub-zone of the at least two sub-zones. The cleaning method also includes, after completing cleaning the first sub-zone, controlling the cleaning robot to return to a charging apparatus for recharging, and, after recharging is completed, controlling the cleaning robot to clean a second sub-zone of the at least two sub-zones.

### CROSS-REFERENCE TO RELATED APPLICATIONS

This application is a continuation of International Application No. PCT/CN2022/086329, filed on Apr. 12, 2022, which claims priority to Chinese Patent Application No. 202110411952.2, filed in Chinese Patent Office on Apr. 16, 2021. The entire content of the above-referenced applications is incorporated herein by reference in this application.

### TECHNICAL FIELD

The present disclosure generally relates to the technology area of smart homes and, in particular, to a cleaning robot, a cleaning method, and a computer-readable storage medium.

### BACKGROUND

In existing technologies, in the process of cleaning a room by a cleaning robot, typically there is a need to monitor the remaining electric power of the cleaning robot in real time. If the remaining electric power of the cleaning robot is below a predetermined value, the cleaning robot may stop cleaning and return to a charging base (also referred to “base” for simplicity) to recharge the battery (simply referred to as a “returning to base for recharging” process). For some cleaning robots disclosed in existing technologies, if, before the cleaning robot returns to the base for recharging, the room-to-be-cleaned still has uncleaned areas, the cleaning robot may return to the room to continue cleaning the uncleaned areas after the battery is fully charged.

However, the indoor simultaneous localization and mapping (referred to as “SLAM”) used for the cleaning robot can have unavoidable accumulative error, and often encounters failure in re-localization. This may cause the cleaning robot to encounter localization error or mapping error during the process of mapping or during the movement based on existing maps. As a result, for a cleaning robot that uses the above-described method to return to the base for recharging and to return to the uncleaned area to continue cleaning after being fully recharged, the cleaning robot may not be able to accurately return to the location where cleaning is stopped right before returning to the base for recharging, to clean the uncleaned area. As such, the cleaning robot may not be able to cover all zones-to-be-cleaned in a closed space that is to be cleaned (e.g., the entire floor in the closed space that is to be cleaned).

In addition, the method of returning to base for recharging based on the remaining electric power of the cleaning robot being lower than the predetermined value may cause the cleaning robot to abruptly return to the base for recharging while working. After the returning to base for recharging process is completed, even if the localization of the cleaning robot can be performed accurately, and the cleaning robot can return to the location, where cleaning is stopped right before returning to base for recharging, to clean the remaining uncleaned areas, for a user, because the user rarely pays attention to the moving path of the cleaning robot, the user can feel that the behavior of the cleaning robot is weird, and may think that the cleaning area is incomplete. This may result in poor user experience.

### SUMMARY OF DISCLOSURE

The objective of the present disclosure is to overcome or at least mitigate the above deficiencies of the existing technologies, and to provide a cleaning robot, a cleaning method, and a computer-readable storage medium.

According to an aspect of the present disclosure, a cleaning method for a cleaning robot is provided. The method includes: obtaining a map of a closed space, wherein the map includes a plurality of rooms corresponding to the closed space. The plurality of rooms are grouped into at least two sub-zones, each sub-zone includes at least one room and each room included in each sub-zone belongs only to the sub-zone; cleaning a first sub-zone of the at least two sub-zones; controlling the cleaning robot to return to a charging apparatus for recharging after the cleaning robot completes cleaning the first sub-zone; cleaning a second sub-zone of the at least two sub-zones after recharging is completed.

According to another aspect of the present disclosure, a cleaning robot is provided. The cleaning robot includes: a motion device configured to move the cleaning robot on a floor of a closed space; a cleaning assembly configured to clean the floor of the closed space; a controller configured to: obtain a map of the closed space, wherein the map of the closed space includes a plurality of rooms corresponding to the closed space, the plurality of rooms are grouped into at least two sub-zones, each sub-zone includes at least one room and each room included in each sub-zone belongs only to the sub-zone; control the cleaning assembly to clean a first sub-zone of the at least two sub-zones; control the motion device such that the cleaning robot returns to a charging apparatus for recharging after completing cleaning of the first sub-zone; control the cleaning assembly to clean a second sub-zone of the at least two sub-zones after the cleaning robot completes recharging.

According to another aspect of the present disclosure, a non-transitory computer-readable storage medium is provided. The storage medium stores computer-readable instructions. When the instructions in the storage medium are executed by a processor of the cleaning robot, the cleaning robot performs the cleaning method described above.

According to the present disclosure, for each sub-zone of the closed space to be cleaned, after the cleaning robot completes cleaning the sub-zone, regardless of how much electric power remains, the cleaning robot returns to the charging apparatus (e.g., a charging base) for recharging, and cleans the next sub-zone after completing recharging (e.g., after battery is fully charged). As such, the disclosed cleaning robot can complete cleaning of all rooms in a sub-zone before the electric power is exhausted, thereby enhancing the user experience. In addition, the issue of the cleaning robot being unable to completely cover all zones to be cleaned in the closed space to be cleaned can be avoided.

According to the detailed descriptions of the illustrative embodiments with reference to the accompanying drawings, the other features and aspects of the present disclosure will become clear.

### BRIEF DESCRIPTIONS OF THE DRAWINGS

The drawings, which form a part of the specification and are included in the specification, together with the specification, show the illustrative embodiments, features, and aspects of the present disclosure, and are used to explain the principle of the present disclosure.

FIG. 1 is a flowchart showing a cleaning method for a cleaning robot, according to an illustrative embodiment of the present disclosure.

FIG. 2 is a map of a closed space, according to an illustrative embodiment of the present disclosure.

FIG. 3 is a flowchart showing a cleaning method for a cleaning robot, according to an illustrative embodiment of the present disclosure.

FIG. 4 is a flowchart showing a method of grouping multiple rooms into sub-zones based on adjacency and connectivity and a predetermined area threshold.

FIG. 5 is a flowchart showing a method of grouping multiple rooms into sub-zones based on adjacency and connectivity and a predetermined mileage value, according to an illustrative embodiment of the present disclosure.

FIG. 6 is a flowchart showing a method of grouping rooms into sub-zones based on adjacency and connectivity and a predetermined electric power statistical value threshold, according to an illustrative embodiment of the present disclosure.

FIG. 7 is a flowchart showing a method of grouping multiple rooms into sub-zones based on adjacency and connectivity and a predetermined time threshold, according to an illustrative embodiment of the present disclosure.

FIG. 8 shows a schematic diagram of a cleaning robot, according to an illustrative embodiment of the present disclosure.

### DETAILED DESCRIPTION

Next, the various illustrative embodiments, features, and aspects of the present disclosure will be described in detail with reference to the accompanying drawings. The same label in the drawings indicate elements having the same or similar functions. Although the drawings show various aspects of the embodiments, the drawings are not drawn to scale, unless otherwise noted.

The term “illustrative” as used herein means “as an example, an embodiment, or explanatory.” Here, any embodiment described using the term “illustrative” does not necessarily mean that the embodiment is more advantageous or better than other embodiments.

In addition, to better explain the present disclosure, various specific details are described in the following detailed implementations. A person having ordinary skills in the art would understand that without certain specific details, the present disclosure can still be implemented. In some embodiments, methods, means, elements, and electric circuits that are well-known to a person having ordinary skills in the art are not described in detail, such that the main principle of the present disclosure can be better illustrated.

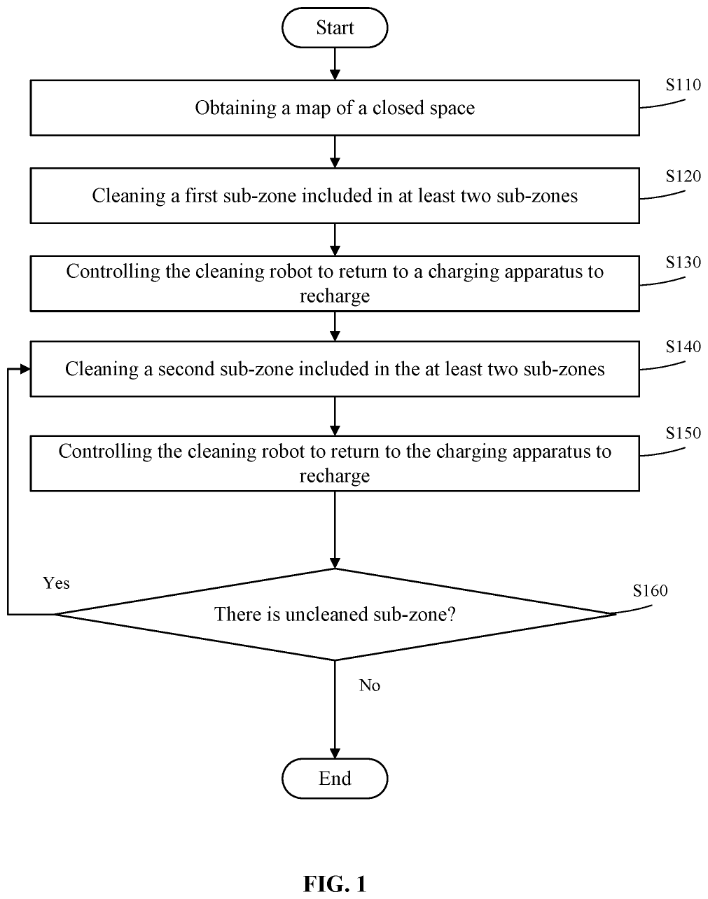

FIG. 1 is a flowchart showing a cleaning method for a cleaning robot, according to an illustrative embodiment of the present disclosure. The cleaning method may be executed by the cleaning robot. The cleaning robot may be, for example, a device that autonomously moves in a closed space of an actual work zone to clean the trash (e.g., dust, dirty water, etc.) on the floor, thereby autonomously cleaning the closed space. The cleaning robot may include, but not be limited to, a smart floor sweeping robot and a smart floor mopping robot.

A plurality of complete rooms in the actual work zone of the cleaning robot form the closed space in which the cleaning robot operates, for example, all indoor space of a home to be cleaned by the cleaning robot. To ensure that the cleaning robot does not move outside of the home, the user typically closes a door that connects the indoor space and the outdoor space, thereby forming a closed work zone, i.e., the closed space. But the closed space is not limited to all of the indoor space of the user, and instead may also be a partial zone formed by a plurality of adjacent complete rooms included in all of the indoor space. For example, the user may close some doors in the home, thereby separating some rooms from all of the indoor space of the home. The remaining space still forms a closed space, which may be a zone-to-be-cleaned for the cleaning robot (such type of zone-to-be-cleaned typically is a zone separated from all of the indoor space of the home by “boundaries” that divide rooms such as wall and closed doors, therefore, this portion of zone-to-be-cleaned is a closed space formed by a plurality of complete rooms).

It should be understood that the cleaning method of the illustrative embodiments can be used for the non-initial (e.g., the second or subsequent) cleaning of the closed space. For the initial cleaning of the closed space, a suitable method in the existing technology may be used. The present disclosure does not provide a description for such a method.

As shown in FIG. 1, the cleaning method of the illustrative embodiment may include the following steps:

Step S110, obtaining a map of a closed space.

In an implementation, the cleaning robot may directly obtain the map of the closed space that is pre-stored from a storage device (e.g., internal storage device or component).

In the illustrative embodiment, the cleaning robot cleaned a closed space before, and already built a map of the closed space and stored it during the cleaning process (e.g., the map of the closed space may be stored in the storage device of the cleaning robot). As such, when the cleaning robot performs subsequent (e.g., second, third, etc.) cleaning of the same closed space according to the cleaning method of the present disclosure, the cleaning robot may directly obtain the map of the closed space from its storage device.

It should be understood that the cleaning robot may use a suitable method of the existing technologies to build the map of the closed space. Due to the limitation of space, the present disclosure does not provide a detailed description of the method adopted by the cleaning robot for building the map of the closed space.

In an implementation, the cleaning robot may obtain the map of the closed space from an external device.

In an illustrative embodiment, the cleaning robot or other cleaning robots, or other autonomously moving smart devices, may establish a communication (wired or wireless) with an external device. During the process of performed a cleaning task of the closed space or other tasks (e.g., area covering tasks such as patrolling, moving cargos, following) by the cleaning robot, or other cleaning robots, or other autonomously moving smart devices, the cleaning robot, or other cleaning robots, or other autonomously moving smart devices may transmit the map of the closed space built in the previous tasks to an external device through the communication link with the external device. As such, when the cleaning robot performs the cleaning method of the present disclosure, the cleaning robot may establish a communication with the external device, transmits a request for the map of the closed space to the external device. The external device may respond to the request for the map of the closed space, and may transmit the map of the closed space to the cleaning robot. Alternatively, the external device may periodically transmit the map of the closed space to the cleaning robot according to a predetermined time period. The external device includes, but is not limited to, a server or a terminal device that can establish a communication with the cleaning robot, such as a server, a cloud device, a distributive network, etc.

In the illustrative embodiment, the map of the closed space may include a plurality of rooms corresponding to the closed space. The plurality of rooms may be grouped into at least two sub-zones, each sub-zone may include at least one room, and each room included in each sub-zone belongs only to this sub-zone.

In some embodiments, for a sub-zone including at least two rooms, for all the rooms included in the sub-zone, at least any two rooms are adjacent to one another, and in adjacent rooms, at least two adjacent rooms are interconnected. However, different adjacent sub-zones may not necessarily have connectivity, i.e., the different sub-zones may not necessarily be connected through a door.

It should be understood that each room in a work zone is formed by its door and walls, and is separated from other rooms by the door and walls. Therefore, each room is the minimum natural unit forming the closed space. In other words, the closed space is formed by rooms. Each sub-zone may include one or more rooms. The one or more rooms included in each sub-zone belong only to this sub-zone and do not belong to other sub-zones. That is, sub-zones do not overlap. Accordingly, when the cleaning robot cleans the closed space based on the map, duplicative cleaning of rooms belonging to multiple sub-zones can be avoided.

In some embodiments, the collection of the sub-zones forms the closed space. That is, the closed space may not include any room that does not belong to any sub-zone. If there were such an independent room, this independent room will form a new sub-zone of itself.

Adjacent rooms refer to two rooms that share at least a portion of the wall and/or room door (also referred to as door for simplicity of discussion).

Two adjacent rooms being interconnected means that the two adjacent rooms are connected through a ground channel that can allow the cleaning robot to pass through at least in certain time period (e.g., a door between two adjacent rooms, a pet door that is disposed low and close to the ground and configured to allow a pet to go through, a cabinet or furniture that has a hollow lower portion that can allow a low object such as a cleaning robot to pass through). Therefore, when the cleaning robot cleans a plurality of rooms that are grouped into a sub-zone, after completing cleaning of a first room in the sub-zone, the cleaning robot may move to a second room that is adjacent to the first room and connected with the first room through a door, such that the cleaning robot can clean the second room. It should be noted that for the simplicity of description, the “door” in the present disclosure represents various configurations in which two adjacent rooms are connected. The door includes, but is not limited to, a door between two adjacent rooms, a pet door disposed low and close to the ground for allowing a pet to pass through, a cabinet or furniture having a hollow lower portion that allows a low object such as a cleaning robot to pass through.

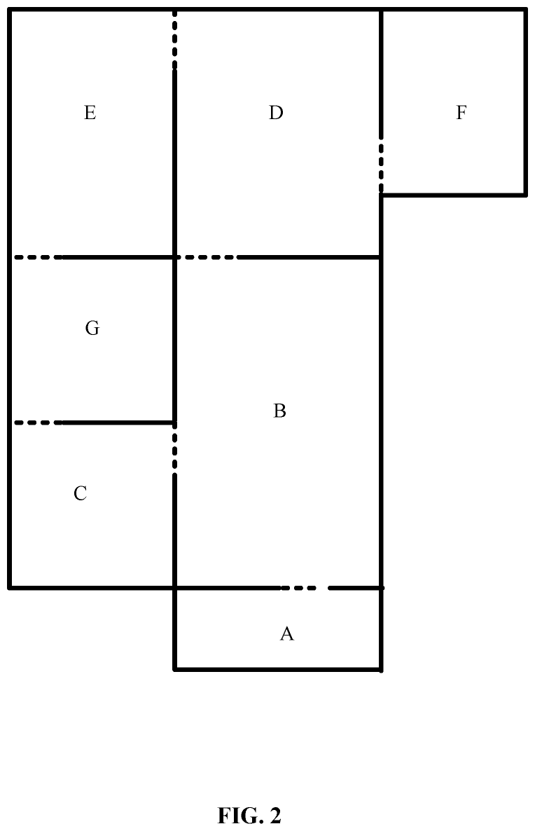

To better understand the term “sub-zone,” next, an explanation is provided using the map of the closed space as shown in FIG. 2 as an example. As shown in FIG. 2, the map of the closed space includes 7 rooms A-G corresponding to the closed space. The dashed line in the figure represents a door that connects two rooms.

In an implementation, rooms E, D, and F in the rooms A-G may be grouped into a first sub-zone, and the remaining rooms, i.e., rooms A, B, C, and G, may be grouped into a second sub-zone.

Referring to FIG. 2, the first sub-zone includes 3 rooms, i.e., rooms E, D, and F. The second sub-zone includes 4 rooms, i.e., rooms A, B, C, and G. The rooms E, D, and F included in the first sub-zone belong only to the first sub-zone and do not belong to the second sub-zone. The rooms A, B, C, and G included in the second sub-zone belong only to the second sub-zone and do not belong to the first sub-zone.

For the first sub-zone, the rooms E and D included therein are adjacent to one another, and are interconnected. The rooms D and F included in the first sub-zone are adjacent to one another, and are interconnected. Similarly, for the second sub-zone, the rooms A and B included therein are adjacent to one another and are interconnected. The rooms B and C included in the second sub-zone are adjacent to one another and are interconnected. The rooms C and G included in the second sub-zone are adjacent to one another and are interconnected. Although rooms B and G are adjacent, they are not interconnected, because there is no door between the two rooms to connect them.

In an implementation, the rooms A-G may be grouped in another manner. That is, the rooms A and B may be grouped into a third sub-zone, the rooms C, G, and E may be grouped into a fourth sub-zone, and the remaining rooms, i.e., rooms D and F, may be grouped into a fifth sub-zone.

Referring to FIG. 2, the third sub-zone includes 2 rooms, i.e., rooms A and B. The fourth sub-zone includes 3 rooms, i.e., rooms C, G, and E. The fifth sub-zone includes 2 rooms, i.e., rooms D and F. The rooms A and B included in the third sub-zone belong only to the third sub-zone and do not belong to the fourth and fifth sub-zones. The rooms C, G, and E included in the fourth sub-zone belong only to the fourth sub-zone and do not belong to the third and fifth sub-zones. The rooms D and F included in the fifth sub-zone belong only to the fifth sub-zone and do not belong to the third and fourth sub-zones.

Similarly, for the third sub-zone, the rooms A and B included therein are adjacent to one another and are interconnected. For the fourth sub-zone, the rooms C and G included therein are adjacent to one another and are interconnected. The rooms G and E included in the fourth sub-zone are adjacent to one another and are interconnected. For the fifth sub-zone, the rooms D and F included therein are adjacent to one another and are interconnected.

The above two examples are merely specific examples of the sub-zones of the map of the closed space shown in FIG. 2. The present disclosure is not limited to these examples. The sub-zones of the map of the closed space shown in FIG. 2 may be realized in other manners. For example, the rooms A, B, and C in the rooms A-G may be grouped into a sixth sub-zone, and the remaining rooms, i.e., rooms G, E, D, and F may be grouped into a seventh sub-zone.

It should be noted that the above first to fifth sub-zones are only names for the sub-zones, and do not have substantive meaning. It should be noted that each sub-zone may be named with any other suitable names. For example, the first sub-zone may be named as a rose zone, the second sub-zone may be named as a pet zone.

In some embodiments, for a sub-zone having at least two rooms, for all rooms included in the sub-zone, any two rooms may not be adjacent to one another, and may not be interconnected.

In some embodiments, different from the above implementations, for all rooms included in the sub-zone, any two rooms need not be adjacent to one another and need not be interconnected. For a sub-zone in which any two rooms are not adjacent to one another and are not interconnected, after completing cleaning of a first room in the sub-zone, the cleaning robot may move to a second room that is included in the sub-zone through a room that is adjacent to the first room and connected with the first room but is not included in the sub-zone, and may then clean the second room. The cleaning robot may continue such processes until all rooms included in the sub-zone have been cleaned.

Illustratively, assuming that a sub-zone includes room 1 and room 2. Room 1 and room 2 are separated by a room 3 located between room 1 and room 2, and room 3 may not belong to the same sub-zone that includes rooms 1 and 2. The cleaning robot may clean room 1, and then move to room 2 by passing through room 3 to clean room 2.

It should be understood that, compared to the sub-zone that includes at least two rooms and for all rooms any two rooms included therein are not adjacent to one another and are not interconnected, for a sub-zone including at least two rooms and for all rooms at least any two rooms are adjacent to one another and among the adjacent rooms at least two adjacent rooms are interconnected, time is saved for moving from an already cleaned room in the sub-zone to another room-to-be-cleaned in the sub-zone.

After obtaining the sub-zones by grouping multiple rooms corresponding to the closed space, the following steps may be executed.

Step S120, controlling the cleaning robot to clean a sub-zone included in at least two sub-zones.

Step S130, controlling the cleaning robot to return to a charging base for recharging after completing cleaning of the current sub-zone.

Step S140, controlling the cleaning robot to clean a next sub-zone included in the at least two sub-zones after recharging is completed.

In illustrative embodiments, in step S140, “cleaning a next sub-zone included in the at least two sub-zones” may be associated with a trigger condition, which may include, but not be limited to, autonomous cleaning (e.g., immediately starting cleaning after recharging is completed or cleaning according to a pre-set time table), or cleaning under control of an instruction from a user. That is, after recharging is completed, the cleaning robot may immediately clean the next sub-zone or may clean the next sub-zone according to a pre-set time. Alternatively, the cleaning robot may receive an instruction from a user that is configured for instructing the cleaning robot to clean the next sub-zone, and may clean the next sub-zone based on the received instruction. As described herein, the phrase “after the recharging is completed” means that the cleaning robot is fully charged, or that the cleaning robot is recharged to a pre-set amount of electric power, or that the cleaning robot is recharged to arrive at an amount of electric power that is sufficient for cleaning the entire area of the next sub-zone.

In some embodiments, after the above steps, the cleaning robot may finish the cleaning of a simple indoor environment.

In some embodiments, in addition to completing the above steps, the cleaning robot may further execute the following steps:

Step S150, after completing cleaning of the next sub-zone, controlling the cleaning robot to return to the charging apparatus for recharging. The charging apparatus may include, but is not limited to, a charging base.

Step S160, determining whether there exists an uncleaned sub-zone.

If the determination is “Yes,” it may indicate that there is an uncleaned sub-zone that needs to be cleaned. Therefore, the step S150 is repeated to clean the remaining uncleaned sub-zone. If the determination is “No,” it may indicate that the cleaning robot has cleaned all sub-zones. Therefore, the cleaning method of the illustrative embodiment can be ended.

In some embodiments, the cleaning robot may start from the charging base, and after cleaning a sub-zone each time, may return to the charging base for recharging regardless of the amount of the remaining electric power. After recharging is completed, the cleaning robot may clean the next sub-zone and may not travel to the already cleaned sub-zone. After cleaning the next sub-zone, the cleaning robot may return to the charging base for recharging regardless of the amount of the remaining electric power. After recharging is completed, the cleaning robot may again clean a subsequent sub-zone and may not travel to the already cleaned sub-zone. This process can be repeated, until all sub-zones are cleaned. It should be noted that the present disclosure does not limit the sequence of cleaning of the sub-zones.

Illustratively, referring back to the example shown in FIG. 2, the cleaning robot may clean a first sub-zone that includes rooms E, D, and F, and after cleaning the first sub-zone that includes rooms E, D, and F, the cleaning robot may return to the charging base for recharging. After recharging is completed, the cleaning robot may clean a second sub-zone that includes the rooms A, B, C, and G. After the second sub-zone that includes rooms A, B, C, and G, the cleaning robot may return to the charging base for recharging. When a work zone only includes two sub-zones, i.e., the first sub-zone and the second sub-zone, after cleaning the second sub-zone, all sub-zones have been cleaned, and the cleaning robot may terminate execution of the cleaning method.

Illustratively, referring to FIG. 2, the cleaning robot may clean a third sub-zone that includes rooms A and B. After cleaning the third sub-zone that includes rooms A and B, the cleaning robot may return to the charging base for recharging. After recharging is completed, the cleaning robot may start from the charging base, and travel to the fourth sub-zone that includes rooms C, G, and E, and may clean the fourth sub-zone. After the fourth sub-zone that includes rooms C, G, and E is cleaned, the cleaning robot may return to the charging base for recharging. Because the fifth sub-zone that includes rooms D and F has not been cleaned, the cleaning robot may start from the charging base, and travel to the fifth sub-zone to clean the fifth sub-zone. After the fifth sub-zone that includes rooms D and F is cleaned, the cleaning robot may return to the charging base for recharging. Because all sub-zones have been cleaned, the cleaning robot may terminate the execution of the cleaning method.

Therefore, in illustrative embodiments, for each sub-zone included in the closed space that is to be cleaned, after the cleaning robot cleans the sub-zone, regardless of the amount of the remaining electric power in the cleaning robot, the cleaning robot executes the returning to base for recharge processes by returning back to a charging apparatus such as the charging base for recharging. After recharging is completed (e.g., after being fully charged), the cleaning robot may clean the next sub-zone. As such, compared to existing technology, according to the present disclosure, cleaning is performed based on the sub-zone as a cleaning unit. After the sub-zone is cleaned, the cleaning robot executes the returning to base for recharging processes regardless of the amount of remaining electric power.

As such, all complete rooms in a sub-zone can be completely cleaned before the electric power is exhausted, thereby improving the user experience. The technical solution of the present disclosure enables the cleaning robot to have sufficient electric power to clean at least a sub-zone. Thus, a potential issue associated with a conventional cleaning robot of not being able to fully clean all areas in a room in one cleaning process can be avoided.

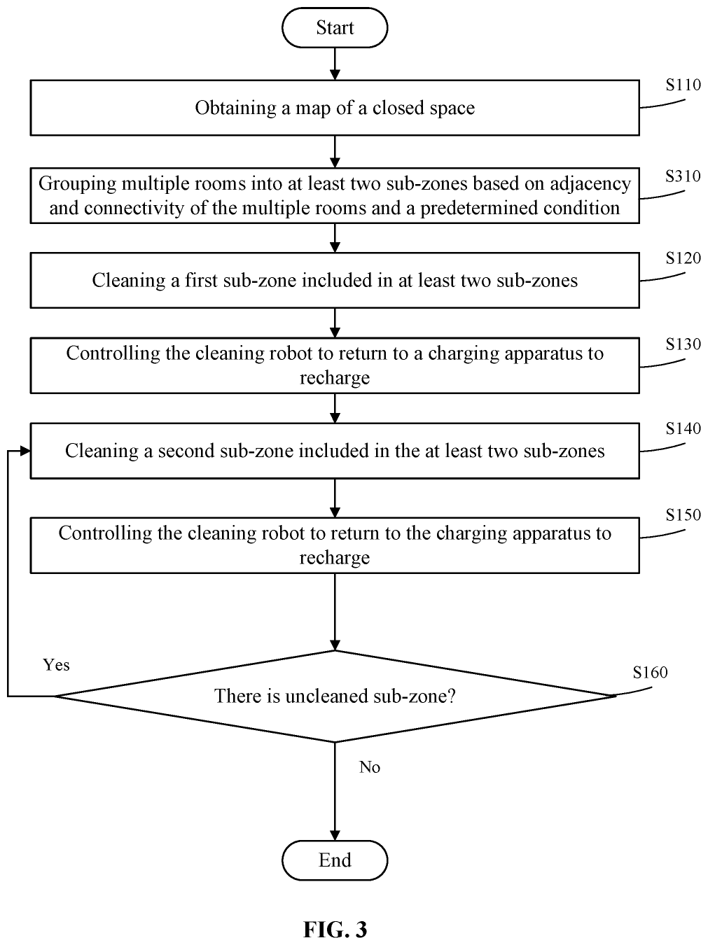

FIG. 3 is a flowchart showing a cleaning method executed by a cleaning robot, according to an illustrative embodiment of the present disclosure. In FIG. 3, the step S310 is added after step S110. Other steps are the same as those shown in FIG. 1, which are not repeated.

Step S310, grouping a plurality of rooms into at least two sub-zones based on adjacency and connectivity of the plurality of rooms and a predetermined condition.

In illustrative embodiments, the phrase “adjacency and connectivity of the plurality of rooms” means that any two rooms of all of the rooms to be grouped into the sub-zone are adjacent to one another, and among the adjacent rooms, at least two adjacent rooms are interconnected.

In an implementation, the predetermined condition may include a sum of areas of multiple rooms in which any two rooms are interconnected equals to or is smaller than a predetermined area threshold. Under this condition, the above-described multiple rooms may be grouped into a sub-zone. That is the grouping rooms into sub-zone may be based on the areas of the rooms.

In illustrative embodiments, if internal tests reveal that the cleaning robot can clean a floor of a predetermined area when consuming a predetermined electric power, such as 50% of the total electric power (e.g., the maximum electric power storage capacity of the battery), then the predetermined area may be set as the predetermined area threshold. It should be noted that there may not be an accurate one-to-one correspondence relationship between the predetermined area threshold and the consumed electric power, and the predetermined area threshold may be manually and subjectively set by a user or tester. In one aspect, because it is unknown where the cleaning robot would be located relative to the charging apparatus when the cleaning robot finishes cleaning of a certain room, sufficient electric power need to be reserved such that the cleaning robot can execute the returning to base for recharging process. In other words, the reason for setting a predetermined electric power is to keep certain redundancy, such that when more electric power is consumed in a same room due to repeated cleaning of an already cleaned zone, which may be caused by external factors such as the cleaning robot being stuck, the cleaning robot repeatedly moving in a certain zone, failure in re-localization, etc., the cleaning robot still has some electric power to return to the charging apparatus for recharging. In another aspect, because the life of the battery is limited, as the number of uses of the battery increases, the maximum capacity of the battery gradually reduces, and the electric power consumption speed will gradually increase. However, the pre-set area threshold may not change as the life of the battery and the electric power consumption speed change. Thus, it is needed to keep certain redundancy such that the cleaning robot can still finish cleaning of a sub-zone when the life of the battery is reduced to a lower level.

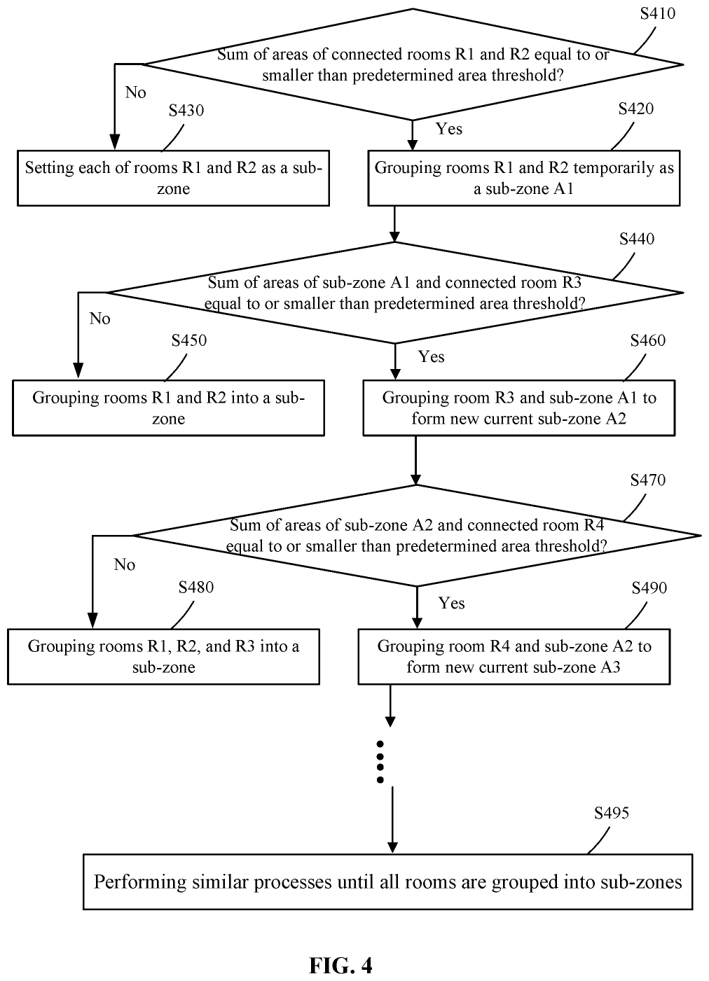

FIG. 4 is a flowchart illustrating grouping of multiple rooms into sub-zones based on the adjacency and connectivity and a predetermined area threshold. Illustratively, assuming that internal tests reveal that the cleaning robot can clean a floor having an area of 100 m² when consuming 50% electric power, then the 100 m² may be set as the predetermined area threshold.

Step S410, determining whether a sum of areas of two rooms R1 and R2 that are interconnected is smaller than or equal to the predetermined area threshold of 100 m². When it is determined that the sum of the areas of the two rooms R1 and R2 that are interconnected is smaller than 100 m², step S420 may be executed. The rooms R1 and R2 may be temporarily grouped into a sub-zone A1, and step S440 may be executed. Otherwise, when it is determined that the sum of areas of the two rooms R1 and R2 that are interconnected is greater than the predetermined area threshold of 100 m², and the area of each of rooms R1 and R2 is smaller than the predetermined area threshold of 100 m², step S430 may be executed to set each of rooms R1 and R2 as a sub-zone separately.

Step S440, determining whether a sum of sub-zone A1 and another room R3 that is interconnected with the current sub-zone A1 is smaller than or equal to the predetermined area threshold of 100 m². When it is determined that the sum of areas of the sub-zone A1 and the other room R3 that is interconnected with the current sub-zone A1 is smaller than the predetermined area threshold of 100 m², step S460 may be executed to group the room R3 into the sub-zone A1 to form a new current sub-zone A2. That is, the sub-zone A2 includes rooms R1, R2, and R3, and step S470 may be executed. Otherwise, when it is determined that the sum of areas of the sub-zone A1 and the other room R3 that is interconnected with the current sub-zone A1 is greater than or equal to the predetermined area threshold of 100 m², step S450 may be executed to group rooms R1 and R2 as a sub-zone.

Step S470, determining whether a sum of areas of sub-zone A2 and another room R4 that is interconnected with the sub-zone A2 is smaller than or equal to the predetermined area threshold of 100 m². When it is determined that the sum of areas of sub-zone A2 and another room R4 that is interconnected with the sub-zone A2 is smaller than the predetermined area threshold of 100 m², step S490 may be executed to group room R4 into the sub-zone A2 to form a new current sub-zone A3. That is, the sub-zone A3 includes the rooms R1, R2, R3, and R4. Then, processes similar to steps S460-S470 may be executed sequentially for the remaining rooms included in the closed space. Otherwise, when it is determined that the sum of areas of sub-zone A2 and another room R4 that is interconnected with the sub-zone A2 is greater than or equal to the predetermined area threshold of 100 m², step 480 may be executed to group rooms R1, R2, and R3 as a sub-zone. Similar processes may be executed until all of the rooms have been grouped into sub-zones (step S495).

In an implementation, the predetermined condition may be a total mileage of the cleaning robot in multiple rooms in which any two rooms are interconnected is smaller than or equal to a predetermined mileage threshold. Under this condition, the above-described multiple rooms may be grouped into a sub-zone, i.e., the grouping of rooms into sub-zones may be performed based on the cleaning trajectory.

In illustrative embodiments, when the number of cleaning operations in a closed space has reached a predetermined value (for generating a permanent map), the cleaning robot may record a moving mileage in each room during the movement process (e.g., the mileage may be calculated using an odometer). In the meantime, based on multiple tests and experience, the predetermined mileage threshold may be manually and subjectively set by a user/tester based on an empirical relationship between the moving mileage and the consumed electric power of the cleaning robot. For example, based on results of multiple tests, if the cleaning robot can clean a floor with a moving mileage of 2000 m when consuming 50% of the electric power, then the 2000 m may be set as the predetermined mileage threshold. It should be noted that there may not be an accurate one-to-one correspondence relationship between the selected predetermined mileage threshold and the consumed electric power, and the selected predetermined mileage threshold may be manually and subjectively set by a user/tester. Because the life of the battery is limited, as the number of uses of the battery increases, the maximum electric capacity of the battery gradually reduces, and the electric power consumption speed will gradually increase. However, the pre-set mileage threshold may not change as the life of the battery and the electric power consumption speed change. Thus, certain redundancy need to be kept when selecting the predetermined mileage threshold, such that the cleaning robot can still finish cleaning of sub-zones that need to be cleaned when the life of the battery is relatively low.

When the total mileage of the cleaning robot moving in multiple rooms is within the predetermined mileage threshold (e.g., less than or equal to the predetermined mileage threshold), the multiple rooms may be grouped into a sub-zone. Because the moving trajectory of the cleaning robot has continuity, the manner of grouping rooms into sub-zones based on a pre-set condition relating to the mileage has already included a determination of the connectivity of the rooms.

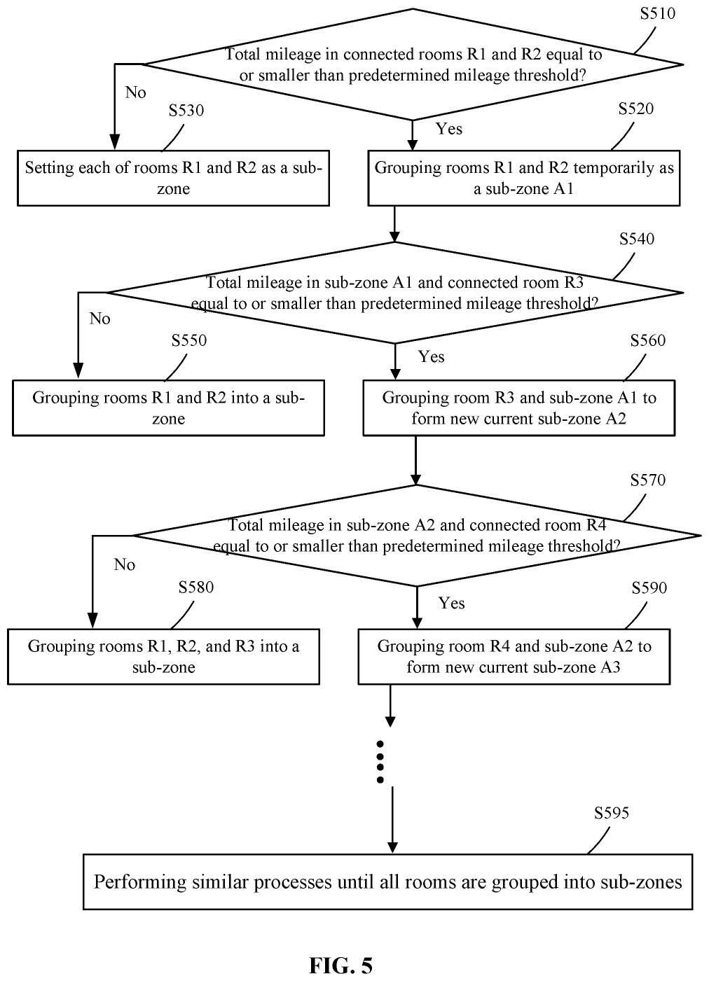

FIG. 5 is a flowchart showing grouping multiple rooms into sub-zones based on adjacency and connectivity and a predetermined mileage threshold, according to an illustrative embodiment of the present disclosure.

Step S510, determining whether a total mileage of the cleaning robot moving in two interconnected rooms R1 and R2 is smaller than or equal to a predetermined mileage threshold of 2000 m. When it is determined that the total mileage of the cleaning robot in two interconnected rooms R1 and R2 is smaller than the predetermined mileage threshold of 2000 m, step S520 may be executed to temporarily group rooms R1 and R2 into a sub-zone A1, and step S540 may be executed. Otherwise, when it is determined that the total mileage of the cleaning robot in two interconnected rooms R1 and R2 is greater than or equal to a predetermined mileage threshold of 2000 m, and the mileage of the cleaning robot in each of rooms R1 and R2 is smaller than the predetermined mileage threshold of 2000 m, step S530 may be executed to set each of rooms R1 and R2 as a sub-zone separately.

Step S540, determining whether a sum of mileages of the cleaning robot moving in the sub-zone A1 and in another room R3 that is interconnected with the current sub-zone A1 is smaller than or equal to the predetermined mileage threshold 2000 m. When it is determined that the sum of mileages of the cleaning robot in the sub-zone A1 and in another room R3 that is interconnected with the current sub-zone A1 is smaller than the predetermined mileage threshold 2000 m, step S560 may be executed to group room R3 into the sub-zone A1 to form a new current sub-zone A2. That is, the sub-zone A2 includes rooms R1, R2, and R3. Then, step S570 may be executed. Otherwise, when it is determined that the sum of mileages of the cleaning robot in the sub-zone A1 and in another room R3 that is interconnected with the current sub-zone A1 is greater than or equal to the predetermined mileage threshold 2000 m, step S550 may be executed to group rooms R1 and R2 as a sub-zone.

Step S570, determining whether the total mileage of the cleaning robot in the sub-zone A2 and in another room R4 that is interconnected with the sub-zone A2 is smaller than or equal to the predetermined mileage threshold 2000 m. When it is determined that the total mileage of the cleaning robot in the sub-zone A2 and in another room R4 that is interconnected with the sub-zone A2 is smaller than the predetermined mileage threshold 2000 m, step S590 may be executed to group the room R4 into the sub-zone A2 to form a new current sub-zone A3. That is, the sub-zone A3 includes rooms R1, R2, R3, and R4. Then, processes similar to steps S560-S570 may be executed sequentially for the remaining rooms in the closed space. Otherwise, when it is determined that the total mileage of the cleaning robot in the sub-zone A2 and in another room R4 that is interconnected with the sub-zone A2 is greater than or equal to the predetermined mileage threshold 2000 m, step S580 may be executed to group rooms R1, R2, and R3 as a sub-zone. Similar processes may be executed until all of the rooms have been grouped into sub-zones (step S595).

In an implementation, the predetermined condition may be, for at least one time in historical cleaning processes of the cleaning robot that a sum of empirical values or statistical values of the electric power consumed by the cleaning robot when moving in the same multiple rooms in which any two rooms are interconnected is smaller than or equal to a predetermined electric power statistical value threshold. Under this condition, the above-described multiple rooms may be grouped into a sub-zone. That is, grouping of rooms into sub-zones may be based on the empirical value or statistical value of the consumed electric power.

In illustrative embodiments, when the number of cleaning operations of the cleaning robot in a closed space reaches a predetermined value (for generating a permanent map), the cleaning robot may automatically record the consumed electric power when cleaning each room during the moving process of the cleaning robot. An empirical value or statistical value of the electric power to be consumed for cleaning a specific room may be calculated based on the recorded historical consumed electric power. A correspondence relationship may be established between this specific room and the electric power empirical value or statistical value corresponding to this room. The user may modify or set the correspondence relationship. A predetermined electric power statistical value threshold may be set based on the correspondence relationship between a room (each room) and the electric power empirical value or statistical value corresponding to the room (the specific each room). For example, the electric power statistical value threshold may be set as an average value of 50% electric power consumption by the cleaning robot in multiple tests of a same room. When the empirical value or statistical value of electric power consumed by the cleaning robot when cleaning multiple rooms is within (e.g., less than or equal to) the manually set predetermined electric power statistical value threshold, then the multiple rooms may be grouped into a sub-zone. It should be noted that in some embodiments, the selected predetermined electric power statistical value threshold may be related to the real time electric power during each movement of the cleaning robot. In some embodiments, the selected predetermined electric power statistical value threshold may be a manually set threshold based on multiple tests, statistics, and experience, and may not be a threshold obtained by real time detection of the electric power. In other words, there may not be an accurate one-to-one correspondence relationship between the selected predetermined electric power statistical value threshold and the real time electric power of the cleaning robot during each actual movement. Because the life of the battery is limited, as the number of uses of the battery increases, the maximum electric power will gradually reduce, and the electric power consumption speed will gradually increase. However, the pre-set electric power statistical value threshold may not change as the life of the battery and the electric power consumption speed change. When selecting the predetermined electric power statistical value threshold, a certain redundancy need to be kept such that the cleaning robot can still finish cleaning of sub-zones that need to be cleaned when the life of the battery is a relatively lower level. Therefore, it may be suitable to set the predetermined electric power statistical value threshold as the average value of the electric power when the cleaning robot consumes about 40% or 50% electric power in multiple tests.

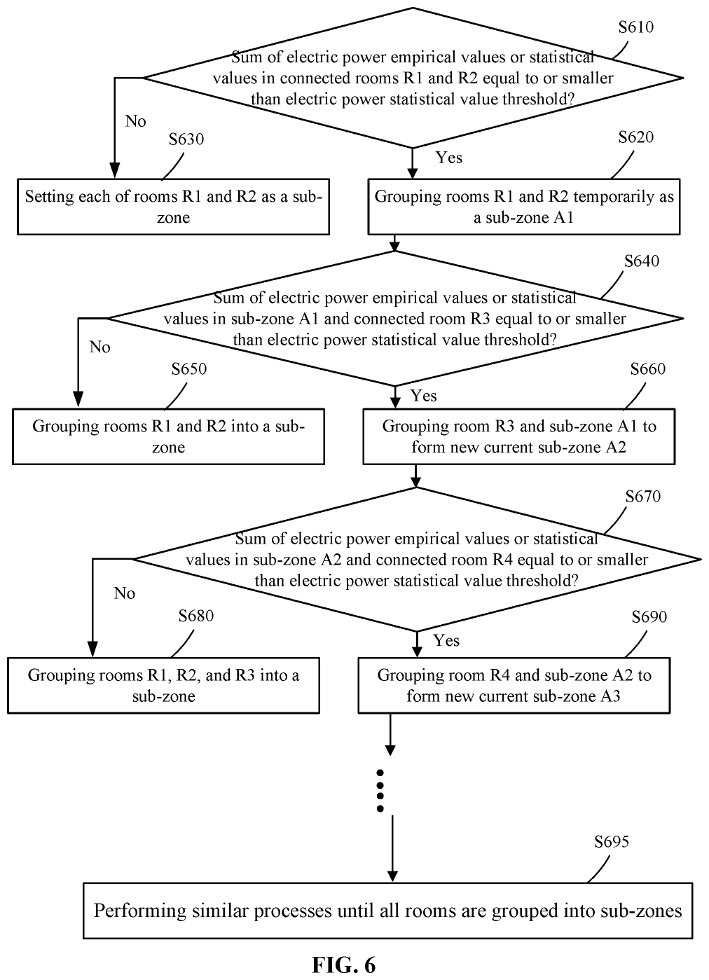

FIG. 6 is a flowchart illustrating grouping a plurality of rooms into sub-zones based on adjacency and connectivity and the predetermined electric power statistical value threshold, according to an illustrative embodiment of the present disclosure.

Step S610, determining whether a sum of the electric power empirical value or statistical value of the cleaning robot in two interconnected rooms R1 and R2 is smaller than or equal to the predetermined electric power statistical value threshold (e.g., 40% or 50% of the total electric power). When it is determined that the sum of the electric power empirical value or statistical value of the cleaning robot in two interconnected rooms R1 and R2 is smaller than the predetermined electric power statistical value threshold, step S620 may be executed to group rooms R1 and R2 into the sub-zone A1, and then step S640 may be executed. Otherwise, when it is determined that the sum of the electric power empirical value or statistical value of the cleaning robot in two interconnected rooms R1 and R2 is greater than or equal to the predetermined electric power statistical value threshold, and the electric power empirical value or statistical value in each of rooms R1 and R2 is smaller than the predetermined electric power statistical value threshold, step S630 may be executed to set each of rooms R1 and R2 as a sub-zone separately.

Step S640, determining whether a sum of the electric power empirical value or statistical value of the cleaning robot in the sub-zone A1 and the electric power empirical value or statistical value in another room R3 that is interconnected with the current sub-zone A1 is smaller than or equal to the predetermined electric power statistical value threshold. When it is determined that the sum of the electric power empirical value or statistical value in the sub-zone A1 and the electric power empirical value or statistical value in room R3 that is interconnected with the current sub-zone A1 is smaller than the predetermined electric power statistical value threshold, step S660 may be executed to group room R3 into the sub-zone A1 to form a new current sub-zone A2. That is, the sub-zone A2 includes rooms R1, R2, and R3. Then, step S670 may be executed. Otherwise, when it is determined that the sum of the electric power empirical value or statistical value in the sub-zone A1 and the electric power empirical value or statistical value in room R3 that is interconnected with the current sub-zone A1 is greater than or equal to the predetermined electric power statistical value threshold, step S650 may be executed to group rooms R1 and R2 into a sub-zone.

Step S670, determining whether a sum of the electric power empirical value or statistical value of the cleaning robot in the sub-zone A2 and the electric power empirical value or statistical value in one or more other rooms that are interconnected with the sub-zone A2 is smaller than or equal to the predetermined electric power statistical value threshold. When it is determined that the sum of the electric power empirical value or statistical value of the cleaning robot in the sub-zone A2 and the electric power empirical value or statistical value in one or more other rooms that are interconnected with the sub-zone A2 is smaller than the predetermined electric power statistical value threshold, step S690 may be executed to group room R4 into the sub-zone A2 to form a new current sub-zone A3. That is, the sub-zone A3 includes rooms R1, R2, R3, and R4. Processes similar to steps S660-S670 may be executed sequentially for the remaining rooms included in the closed space. Otherwise, when it is determined that the sum of the electric power empirical value or statistical value in the sub-zone A2 of the cleaning robot and the electric power empirical value or statistical value in one or more other rooms that are interconnected with the sub-zone A2 is greater than the predetermined electric power statistical value threshold, step S680 may be executed to group rooms R1, R2, and R3 into a sub-zone. Similar processes may be executed until all rooms in the closed space are grouped into sub-zones (step S695).

It should be noted that in the illustrative embodiments there may not be an one-to-one correspondence relationship between the “electric power empirical value or statistical value” and the electric power statistical value threshold and the electric power obtained by real time detection. The reason is: the electric power may be calculated in real time, and the electric power empirical value or statistical value may be manually selected by a user/tester based on empirical values or statistical values of the electric power consumed by the cleaning robot when moving in the same closed space during historical cleaning processes.

In some embodiments, the electric power statistical value may be an average value of the electric power consumed by the cleaning robot in multiple movements in the same room, such as an arithmetic mean, a room mean square, or a weighted arithmetic mean. If it is a weighted arithmetic mean, then a physical parameter or a motion parameter may be used as the weight. For example, the motion mode may be used as the weight to perform the weighted average. In an example, the weight in a silent mode may be 0.5, the weight in a normal mode may be 1, and the weight in a super-clean mode may be 2. Alternatively, the moving speed or main brush power may be used as the weight to perform the weighted average. The electric power statistical value is a statistical average result of the electric power that is actually consumed. Therefore, the user may not directly modify this electric power statistical value. But the electrical power statistical value may be modified through modifying the statistical formula and/or weight.

In an implementation, the predetermined condition may include: for at least one time in historical cleaning processes of the cleaning robot that a sum of historical time spent in moving in the same multiple rooms in which any two rooms are interconnected is equal to or smaller than a predetermined time threshold. Under this condition, the above-described multiple rooms may be grouped into a sub-zone. That is, the grouping of rooms into sub-zones may be performed based on the cleaning time.

In illustrative embodiments, when the number of cleaning operations by the cleaning robot in the closed space reaches a predetermined number (for generating a permanent map), the cleaning robot may automatically record time spent in cleaning each room during the movement. An empirical correspondence relationship may be established between the room and the time spent corresponding to the specific room. A predetermined time threshold may be manually set by a user/tester based on the total electric power and the empirical correspondence relationship. For example, based on results of multiple tests, the cleaning robot consumes 50% of the electric power when moving for 1 hour under certain operation mode, then the 1 hour may be set as the predetermined time threshold. If the sum of the time spent for cleaning multiple rooms by the cleaning robot is within this predetermined time threshold (e.g., smaller than or equal to the predetermined time threshold), then the multiple rooms may be grouped into a sub-zone. It should be noted that here there may not be an one-to-one correspondence relationship between the selected predetermined time threshold and the actually consumed electric power. The selected predetermined time threshold may be manually and subjectively set by a user/tester. Because the life of the battery is limited, as the number of uses of the battery increases, the maximum electric power will gradually decrease, and the power consumption speed will gradually increase. However, the predetermined time threshold may not change as the life of the battery and the power consumption speed change. Therefore, certain redundancy need to be kept when selecting the predetermined time threshold, such that the cleaning robot can still clean all sub-zones that need to be cleaned when the life of the battery is at a relatively lower level.

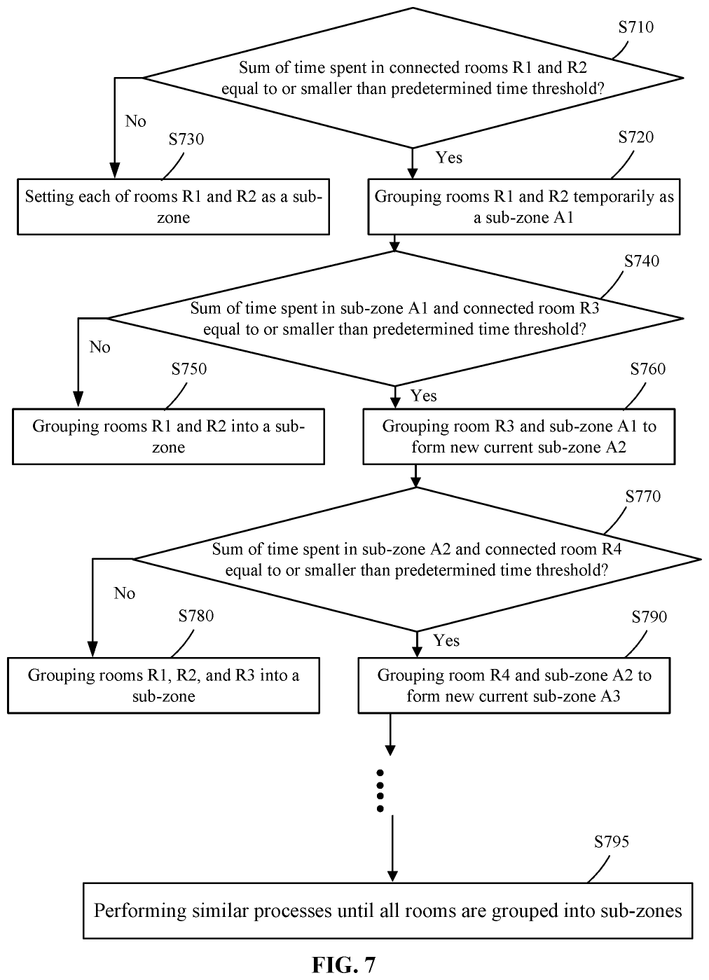

FIG. 7 is a flowchart illustrating grouping of multiple rooms into sub-zones based on the adjacency and connectivity and a predetermined time threshold, according to an illustrative embodiment of the present disclosure.

Step S710, determining whether a sum of time spent in two interconnected rooms R1 and R2 is smaller than or equal to a predetermined time threshold of 1 hour. When it is determined that when the sum of time spent in two interconnected rooms R1 and R2 is smaller than the predetermined time threshold of 1 hour, step S720 may be executed to temporarily group rooms R1 and R2 into a sub-zone A1, and step S740 may be executed. Otherwise, when it is determined that the sum of time spent in two interconnected rooms R1 and R2 is greater than or equal to the predetermined time threshold of 1 hour, and the time spent in each of rooms R1 and R2 is smaller than the predetermined time threshold of 1 hour, step S730 may be executed to set each of rooms R1 and R2 as a sub-zone separately.

Step S740, determining whether the sum of time spent in the sub-zone A1 and the time spent in another room R3 that is interconnected with the current sub-zone A1 is smaller than or equal to the predetermined time threshold of 1 hour. When it is determined that the sum of time spent in the sub-zone A1 and the time spent in another room R3 that is interconnected with the current sub-zone A1 is smaller than the predetermined time threshold of 1 hour, step S760 may be executed to group room R3 into the sub-zone A1 to form a new current sub-zone A2. That is, the sub-zone A2 includes rooms R1, R2, and R3. Then step S770 may be executed. Otherwise, when it is determined that the sum of time spent in the sub-zone A1 and the time spent in another room R3 that is interconnected with the current sub-zone A1 is greater than or equal to the predetermined time threshold of 1 hour, step S750 may be executed to group rooms R1 and R2 into a sub-zone.

Step S770, determining whether the sum of time spent in the sub-zone A2 and the time spent in another room R4 that is interconnected with the sub-zone A2 is smaller than or equal to the predetermined time threshold of 1 hour. When it is determined that the sum of time spent in the sub-zone A2 and the time spent in another room R4 that is interconnected with the sub-zone A2 is smaller than the predetermined time threshold of 1 hour, step S790 may be executed to group room R4 into the sub-zone A2 to form a new current sub-zone A3. That is, the sub-zone A3 includes rooms R1, R2, R3, and R4. Processes similar to steps S760-S770 may be executed sequentially for the remaining rooms included in the closed space. Otherwise, When it is determined that the sum of time spent in the sub-zone A2 and the time spent in another room R4 that is interconnected with the sub-zone A2 is greater than or equal to the predetermined time threshold of 1 hour, step S780 may be executed to group rooms R1, R2, and R3 into a sub-zone. Similar processes may be executed until all rooms are grouped into sub-zones (step S795).

It should be understood that if a room cannot be grouped into a sub-zone, for example, if there is a remaining room after sub-zones are formed, this room may be set as a sub-zone.

It should be noted that the above describes the detailed examples of the predetermined condition. The present disclosure is not limited to those discussed herein. A person having ordinary skills in the art can reasonably select other suitable condition as the predetermined condition based on the disclosed content of the present disclosure and the technical knowledge of the person.

In an implementation, multiple rooms may be grouped into at least two sub-zones based on the adjacency and connectivity of the multiple rooms, a predetermined condition, and a least number of sub-zones principle.

In some embodiments, based on the grouping methods described above for forming the sub-zones, the sub-zones may be further grouped based on the least number of sub-zones principle. As used herein, the “least number of sub-zones principle” means that the number of sub-zones included in the closed space is at a minimum. Thus, the number of returning to base for recharging processes can be reduced, which improves the user experience.

In an implementation, the closed space may be divided into sub-zones based on the map of the closed space. Multiple rooms may be divided in the map of the closed space, such that the map of the closed space includes multiple rooms corresponding to the closed space.

In some embodiments, automatic division or manual division may be performed to the closed space based on the map of the closed space. A person having ordinary skills in the art can perform the automatic division or manual division based on any suitable method in the existing technology. Due to the limit on space, the present disclosure does not provide a detailed description of the automatic division and manual division.

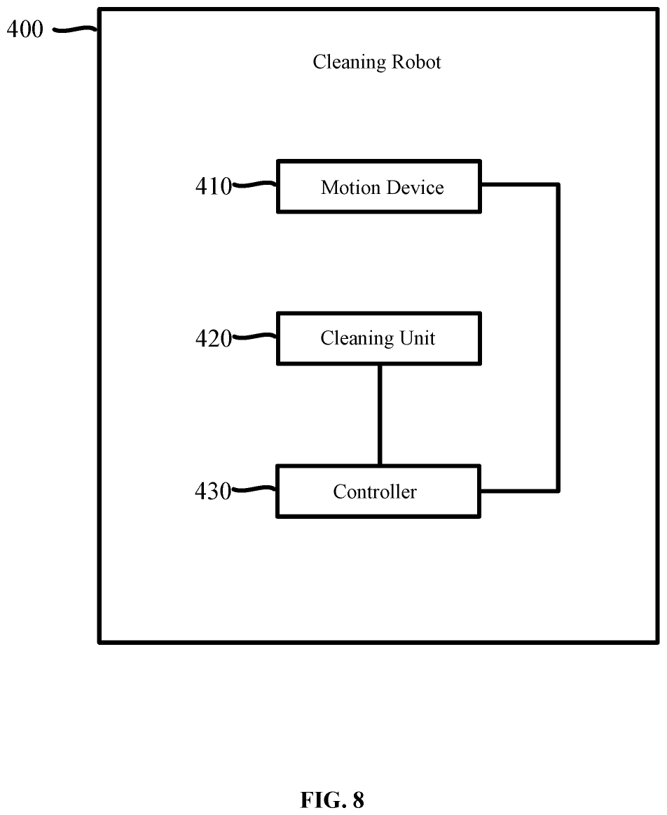

FIG. 8 is a schematic diagram of a cleaning robot according to an illustrative embodiment of the present disclosure. As shown in FIG. 8, the cleaning robot 400 may include a motion device 410, a cleaning assembly 420, and a controller 430. The motion device 410 may be configured to move the cleaning robot 400 on a floor of the closed space. The cleaning assembly 420 may be configured to clean the floor of the closed space, and may include one or more suitable cleaning components, such as a brush, a mopping plate, a vacuum cleaner, etc. The controller 430 may be connected with the motion device 410 and the cleaning assembly 420, and may be configured to obtain the map of the closed space.

The map of the closed space may include multiple rooms corresponding to the closed space. The multiple rooms may be grouped into at least two sub-zones. Each sub-zone may include at least one room, and each room included in each sub-zone belongs only to this sub-zone. The controller 430 may be configured to control the cleaning assembly 420 to clean a first sub-zone in the at least two sub-zones. After finishing cleaning the first sub-zone, the controller 430 may control the motion device 410 to return to the charging apparatus for recharging. After the cleaning robot finishes recharging, the controller 430 may control the cleaning assembly 420 to clean a second sub-zone in the at least two sub-zones.

In an implementation, for a sub-zone including at least two rooms, any two rooms of the rooms included in the sub-zone are adjacent to one another, and in adjacent rooms, at least two adjacent rooms are interconnected.

In an implementation, the controller 430 may be configured to group multiple rooms into at least two sub-zones based on the adjacency and connectivity of the multiple rooms and a predetermined condition.

In an implementation, the predetermined condition may include:
a sum of areas of multiple rooms in which any two rooms are interconnected is equal to or smaller than a predetermined area threshold; or
a total mileage of the motion device 410 moving in multiple rooms in which any two rooms are interconnected is equal to or smaller than a predetermined mileage threshold; or
for at least one time in historical cleaning processes of the cleaning robot that a sum of statistical values of the electric power consumed when the cleaning robot moves in the same multiple rooms in which any two rooms are interconnected is equal to or smaller than a predetermined electric power statistical value threshold; or
for at least one time in historical cleaning processes of the cleaning robot that a sum of historical time spent when the cleaning robot moves in the same multiple rooms in which any two rooms are interconnected is equal to or smaller than a predetermined time threshold.

In an implementation, the controller 430 may be configured to group the multiple rooms into at least two sub-zones based on the least number of sub-zones principle.

In an implementation, the controller 430 may be configured to divide the closed space based on the map of the closed space, such that multiple rooms are divided in the map of the closed space, and the map of the closed space includes the multiple rooms corresponding to the closed space.

In the above-described device or apparatus, the detailed operations executed by each unit have been described in detail in the embodiment of the related method, which are not repeated.

The above describes various embodiments of the present disclosure, which are illustrative, and are not exhaustive, and the present disclosure is not limited to the described embodiments. Without deviating from the scope and spirit of each described embodiment, for a person having ordinary skills in the art, many modifications and changes are obvious. The selection of the terms used in this disclosure is for the purpose of providing a best explanation of the principles of the various embodiments, the actual implementation, or technical improvements in the market, or to enable a person having ordinary skills in the art to better understand the various embodiments of the present disclosure.

What is claimed is:

1. A cleaning method for a cleaning robot, comprising:
obtaining a map of a closed space, the map including a plurality of rooms corresponding to the closed space, wherein the plurality of rooms being grouped into at least two sub-zones, each sub-zone including at least one room, and each room included in each sub-zone belongs only to the sub-zone;
cleaning a first sub-zone included in the at least two sub-zones;
after completing cleaning the first sub-zone, controlling the cleaning robot to return to a charging apparatus for recharging; and
after completing recharging, controlling the cleaning robot to clean a second sub-zone included in the at least two sub-zones.

2. The cleaning method of claim 1, wherein
for a sub-zone that includes at least two rooms, any two rooms of the at least two rooms included in the sub-zone are adjacent to one another, and in adjacent rooms, at least two adjacent rooms are interconnected.

3. The cleaning method of claim 2, further comprising:
grouping the plurality of rooms into the at least two sub-zones based on adjacency and connectivity of the plurality of rooms and a predetermined condition.

4. The cleaning method of claim 3, wherein the predetermined condition includes:
a sum of areas of a plurality of rooms in which any two rooms are interconnected is equal to or smaller than a predetermined area threshold; or
a total mileage of the cleaning robot when moving in a plurality of rooms in which any two rooms are interconnected is equal to or smaller than a predetermined mileage threshold; or
for at least one time in historical cleaning processes of the cleaning robot, a sum of statistical values of electric power consumed by the cleaning robot in the same plurality of rooms in which any two rooms are interconnected is equal to or smaller than a predetermined electric power statistical value threshold; or
for at least one time in historical cleaning processes of the cleaning robot, a sum of empirical values of electric power consumed by the cleaning robot in the same plurality of rooms in which any two rooms are interconnected is equal to or smaller than a predetermined electric power empirical value threshold; or
for at least one time in historical cleaning processes of the cleaning robot, a sum of historical time spent by the cleaning robot in the same plurality of rooms in which any two rooms are interconnected is equal to or smaller than a predetermined time threshold.

5. The cleaning method of claim 3, further comprising:
grouping the plurality of rooms into the at least two sub-zones based on a least number of sub-zones principle.

6. The cleaning method of claim 1, further comprising:
dividing the closed space based on the map of the closed space, such that the map of the closed space includes the plurality of rooms corresponding to the closed space.

7. A cleaning robot, comprising:
a motion device configured to move the cleaning robot on a floor of a closed space;
a cleaning assembly configured to clean the floor of the closed space;
a controller configured to:
obtain a map of the closed space, the map of the closed space including a plurality of rooms corresponding to the closed space, wherein the plurality of rooms are grouped into at least two sub-zones, each sub-zone includes at least one room and each room included in each sub-zone belongs only to the sub-zone;
control the cleaning assembly to clean a first sub-zone included in the at least two sub-zones;
after completing cleaning of the first sub-zone, control the motion device to return to a charging apparatus for recharging; and
after completing recharge, controlling the cleaning assembly to clean a second sub-zone included in the at least two sub-zones.

8. The cleaning robot of claim 7, wherein
for a sub-zone including at least two rooms, any two rooms of the at least two rooms included in the sub-zone are adjacent to one another, and in adjacent rooms, at least two adjacent rooms are interconnected.

9. The cleaning robot of claim 8, wherein the controller is also configured to:
group the plurality of rooms into the at least two sub-zones based on adjacency and connectivity of the plurality of rooms and a predetermined condition.

10. The cleaning robot of claim 9, wherein the predetermined condition includes:
a sum of areas of a plurality of rooms in which any two rooms are interconnected is equal to or smaller than a predetermined area threshold; or
a total mileage of the cleaning robot when moving in a plurality of rooms in which any two rooms are interconnected is equal to or smaller than a predetermined mileage threshold; or
for at least one time in historical cleaning processes of the cleaning robot, a sum of statistical values of electric power consumed by the cleaning robot in the same plurality of rooms in which any two rooms are interconnected is equal to or smaller than a predetermined electric power statistical value threshold; or
for at least one time in historical cleaning processes of the cleaning robot, a sum of empirical values of electric power consumed by the cleaning robot in the same plurality of rooms in which any two rooms are interconnected is equal to or smaller than a predetermined electric power empirical value threshold; or
for at least one time in historical cleaning processes of the cleaning robot, a sum of historical time spent by the cleaning robot in the same plurality of rooms in which any two rooms are interconnected is equal to or smaller than a predetermined time threshold.

11. The cleaning robot of claim 9, wherein the controller is also configured to:
group the plurality of rooms into the at least two sub-zones based on a least number of sub-zones principle.

12. The cleaning robot of claim 7, wherein the controller is also configured to:
divide the closed space based on the map of the closed space, such that the map of the closed space includes the plurality of rooms corresponding to the closed space.

13. A non-transitory computer-readable storage medium storing computer-executable program instructions, wherein when the computer-executable program instructions are executed by a processor, the processor controls a cleaning robot to perform a cleaning method comprising:
obtaining a map of a closed space, the map including a plurality of rooms corresponding to the closed space, wherein the plurality of rooms being grouped into at least two sub-zones, each sub-zone including at least one room, and each room included in each sub-zone belongs only to the sub-zone;
cleaning a first sub-zone included in the at least two sub-zones;
after completing cleaning the first sub-zone, controlling the cleaning robot to return to a charging apparatus for recharging; and
after completing recharging, controlling the cleaning robot to clean a second sub-zone included in the at least two sub-zones.

14. The non-transitory computer-readable storage medium of claim 13, wherein
for a sub-zone that includes at least two rooms, any two rooms of the at least two rooms included in the sub-zone are adjacent to one another, and in adjacent rooms, at least two adjacent rooms are interconnected.

15. The non-transitory computer-readable storage medium of claim 14, wherein the method further comprises:
grouping the plurality of rooms into the at least two sub-zones based on adjacency and connectivity of the plurality of rooms and a predetermined condition.

16. The non-transitory computer-readable storage medium of claim 15, wherein the predetermined condition includes:
a sum of areas of a plurality of rooms in which any two rooms are interconnected is equal to or smaller than a predetermined area threshold; or
a total mileage of the cleaning robot when moving in a plurality of rooms in which any two rooms are interconnected is equal to or smaller than a predetermined mileage threshold; or
for at least one time in historical cleaning processes of the cleaning robot, a sum of statistical values of electric power consumed by the cleaning robot in the same plurality of rooms in which any two rooms are interconnected is equal to or smaller than a predetermined electric power statistical value threshold; or
for at least one time in historical cleaning processes of the cleaning robot, a sum of empirical values of electric power consumed by the cleaning robot in the same plurality of rooms in which any two rooms are interconnected is equal to or smaller than a predetermined electric power empirical value threshold; or
for at least one time in historical cleaning processes of the cleaning robot, a sum of historical time spent by the cleaning robot in the same plurality of rooms in which any two rooms are interconnected is equal to or smaller than a predetermined time threshold.
